(19) United States
(12) Patent Application Publication
(10) Pub. No.: US 2001/0026205 A1
(43) Pub. Date: Oct. 4, 2001

(54) Gapped toroidal inductors

(75) Inventors: Henry G. Paris, Chattanooga, TN (US); Richard W. Meadors, Chattanooga, TN (US); Dennis M. Daniels, Chattanooga, TN (US)

Correspondence Address: CHRISTOPHER F. REGAN, Allen, Dyer, Doppelt, Milbrath & Gilchrist, P.A., P.O. Box 3791, Orlando, FL, 32802-3791, US

(73) Assignee: STEWARD, INC.

(21) Appl. No.: 09/766,891

(22) Filed: Jan. 19, 2001

Related U.S. Application Data
(60) Provisional application No. 60/177,086, filed on Jan. 20, 2000.
(60) Provisional application No. 60/208,867, filed on Jun. 2, 2000.

(51) Int. Cl. H01F 3/00

(52) U.S. Cl. 335/297

(57) ABSTRACT

A toroidal inductor includes a toroidal core including magnetic material and having at least one magnetic flux gap therein, and at least one conductor wound on the core. The magnetic flux gap may include a non-magnetic material having a substantially uniform thickness between respective adjacent magnetic material portions. In some embodiments, the non-magnetic material may have a shrinkage factor during sintering substantially equal to a shrinkage factor of the magnetic material. For example, the magnetic material may include ferrite, and the non-magnetic material may include alumina or zinc ferrite. In some embodiments, the flux gap may be provided by an air gap. The substantially uniform thickness of the at least one magnetic flux gap is readily and accurately produced in accordance with associated manufacturing aspects of the invention.

### RELATED APPLICATION

The present application is based upon provisional application Ser. No. 60/177,086, filed Jan. 20, 2000, and provisional application Ser. No. 60/208,867, filed Jun. 2, 2000, both of which are hereby incorporated herein in their entireties by reference.

### FIELD OF THE INVENTION

The present invention relates to the field of electrical devices, and, more particularly, to toroidal inductors.

### BACKGROUND OF THE INVENTION

Power supplies and converters in information technology and telecommunications systems typically use inductive components which must function at higher and higher frequencies and operate in more severe environments. The space available for such components has shrunk as the size of the power supply has become very small, yet the device must deliver very uniformly the necessary inductance over a broad range of temperature and drive or DC bias.

At the switching frequencies involved, ferrite cores form the basis for the preferred approaches in these applications, and toroidal shapes are often the most cost effective approach. Other applications where space limitation is an important factor include the incorporation of inductors on computer cards made according to Personal Computer Memory Card International Association (PCMCIA) standards, in cell phones, and in compact logic devices. Stable inductance with respect to drive or DC bias at elevated temperature is highly desirable.

Various methods for making inductors with toroidal cores are known in the art. For example, U.S. Pat. No. 5,876,539 to Bailey et al. entitled “Fabrication of Ferrite Toroids” discloses using selectively cut layers of green tape for forming a ferrite toroid. In particular, prelaminated tape layers are aligned on an assembly plate including a set of alignment pins corresponding to the hole pattern for the holes formed in the layers. The assembly is placed in a laminating fixture and subjected to pressing for forming a toroid sheet. Afterwards, the toroid sheet is fired to obtain a toroid sheet of ferrite. The toroid sheet of ferrite is bonded to another toroid sheet of ferrite with a sheet of dielectric therebetween. Toroid pairs are cut from the bonded toroid sheets.

Another example is found in U.S. Pat. No. 3,535,200 to Bergstrom entitled “Multilayered Mechanically Oriented Ferrite.” This patent discloses punching a toroid from a stacked layer of laminated ferrite sheets. Japanese Patent No. 55-12795 to Miyoshi discloses a disc-shaped magnetic material formed by punching through a plurality of magnetic sheets.

One limitation of the above approaches is that they do not provide for the formation of magnetic flux gaps in the toroidal core. The inductance of the device is a function of the effective permeability of the core μₑ. As the drive H increases, the flux density B increases but μₑ falls off as the core approaches saturation, and the inductive device loses its stability. A change in temperature will cause the permeability to shift, which also contributes to the instability of the device. Magnetic flux gaps may be used to maintain stability of the device. Magnetic flux gaps may be inserted in the magnetic path to increase reluctance and lower the effective permeability of the core. While this will also lower the inductance, a slight change in the size of the toroid can offset this inductance change.

One example of a toroidal core including a magnetic flux gap is disclosed in U.S. Pat. No. 1,286,965 to Elmen entitled “Magnetic Core.” This patent discloses a slit cut through one side of a the magnetic core. The slit is cut after the core has been formed. Other examples may be found in U.S. Pat. Nos. 3,548,492 and 3,670,406 to Weber, both of which are entitled “Method of Adjusting Inductive Devices.” These patents disclose a method of using a flow of abrasive-filled air to form an air gap in a toroid to adjust the inductance of the toroid by removing a portion of the core.

Still another example is provided in U.S. Pat. No. 2,836,881 to Pollock entitled “Method of Making Transducer Cores.” This patent discloses a method of reducing the cross-sectional area of a toroidal core at a desired gap location by notching its internal periphery in a deep “V”. The core is then clamped radially on both sides of the V, and a stretching force is applied tangentially to the core at the notched portion until a fracture or gap occurs. The gap permits insertion of a thin shim of silver or equivalent material. Once the stretching force is removed, the gap is closed against the thin shim of silver.

Another approach to making toroidal inductors includes sawing ferrite tubes into halves, and gluing the halves together. Unfortunately, the adhesive or glue may not provide mechanical ruggedness or stability of operation at high bias currents and/or high temperatures.

The above methods for forming magnetic flux gaps in toroidal cores have several other disadvantages. First, each of these methods requires additional processing steps after formation of the toroidal core, which may increase production time and costs. Furthermore, the tolerances of these methods may not be great enough to provide magnetic flux gaps which are sufficiently thin for certain applications. Additionally, these methods may be difficult to implement in practice.

### SUMMARY OF THE INVENTION

In view of the foregoing background, it is therefore an object of the present invention to provide a toroidal inductor including at least one magnetic flux gap that may be produced without significantly increasing manufacturing costs or complexity.

This and other objects, features, and advantages in accordance with the present invention are provided by a toroidal inductor comprising a toroidal core including magnetic material and having at least one magnetic flux gap therein, and at least one conductor wound on the core. The magnetic flux gap may comprise a non-magnetic material having a substantially uniform thickness between respective adjacent magnetic material portions. In addition, in some embodiments the non-magnetic material may have a shrinkage factor during sintering substantially equal to a shrinkage factor of the magnetic material. For example, the magnetic material may comprise ferrite, and the nonmagnetic material may comprise alumina or zinc ferrite. The substantially uniform thickness of the at least one magnetic flux gap is readily and accurately produced in accordance with associated manufacturing aspects of the invention. Accordingly, a rugged and stable inductor is provided.

The at least one magnetic flux gap may comprise a single flux gap which may extend along a radius of the toroidal core. Alternately, the at least one magnetic flux gap may comprise a pair of flux gaps aligned along opposing radii of the toroidal core.

In some embodiments, the at least one magnetic flux gap may comprise a plurality of nonmagnetic material layers and spacer layers between adjacent ones thereof. Each spacer layer may comprise ferrite.

In other embodiments, the non-magnetic material may comprise air so that the at least one nonmagnetic flux gap comprises at least one air gap. For the air gap embodiments, the toroidal core may comprise substantially continuous top and bottom portions and which contain the at least one air gap therebetween.

### BRIEF DESCRIPTION OF THE DRAWINGS

FIG. 1 is a perspective view of a toroidal inductor according to the present invention.

FIG. 2 is a greatly enlarged plan view of the magnetic flux gap portion of the toroidal inductor as shown in FIG. 1.

FIG. 3 is a perspective view of an ellipsoidal inductor according to the present invention and with the wound conductor removed for clarity.

FIG. 4 is a perspective view of a “squaroidal” inductor according to the present invention and with the wound conductor removed for clarity.

FIG. 5 is a perspective view of an E-core inductor according to the present invention and with the wound conductor removed for clarity.

FIG. 6 is a perspective view of a “binocular” inductor according to the present invention and with the wound conductor removed for clarity.

FIG. 7 is a perspective view of an alternate embodiment of the toroidal inductor as shown in FIG. 1 and with the wound conductor removed for clarity.

FIGS. 8-11 are perspective views illustrating a method of making the toroidal inductor as shown in FIG. 1.

FIG. 12 is a perspective view of another toroidal inductor according to the present invention also with the wound conductor removed for clarity.

FIG. 13 is a perspective view of an alternative embodiment of the toroidal inductor as shown in FIG. 12.

FIGS. 14-18 are perspective views illustrating a method of making the toroidal inductor of FIG. 12.

FIG. 19 is a perspective view of still another embodiment of a toroidal inductor according to the present invention.

FIG. 20 is a greatly enlarged cross-sectional view of the air gap portion of the toroidal inductor as shown in FIG. 19.

FIGS. 21 and 22 are perspective views illustrating a method of making of the toroidal inductor as shown in FIGS. 19 and 20.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

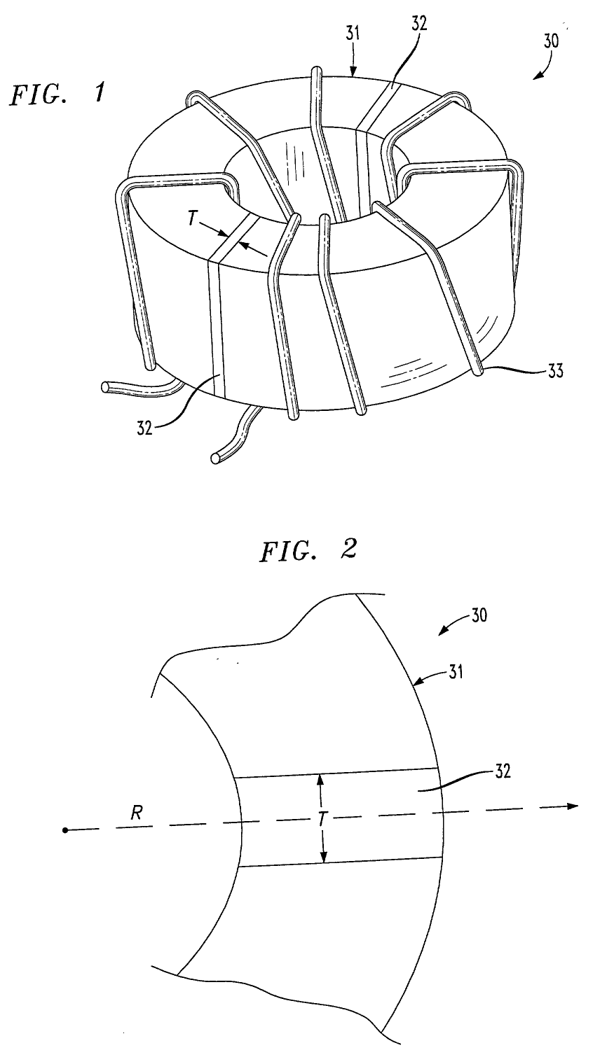

Referring now to FIGS. 1 and 2, a toroidal inductor 30 according to one embodiment of the present invention is now described. The toroidal inductor 30 illustratively includes a toroidal core 31 including a pair of magnetic flux gaps 32 in the toroidal core. The flux gaps 32 are aligned along opposing radii R of the core. In other embodiments, the flux gaps 32 may be offset from the respective radii.

The toroidal core 31 includes a magnetic material, such as ferrite, and the magnetic flux gaps 32 may include a solid, non-magnetic material. The solid non-magnetic material may be alumina or zinc ferrite, for example. Alumina typically includes not less than about 80% aluminum oxide along with other materials, such as silicon, calcium, and/or magnesium, for example. The magnetic flux gaps 32 each have a substantially uniform thickness T and are illustratively aligned along a radius R of the toroidal core 31. As will be appreciated by those skilled in the art, the uniform thickness T is a result of the efficient manufacturing processes described in greater detail below. The toroidal inductor 30 also illustratively includes a conductor 33, such as a metal wire, wound around the toroidal core 31.

The toroidal core 31 is one particularly advantageous embodiment of a broader class of inductor cores which can generally be considered to have a closed-shape with at least one flux gap therein. Closed-shape may also be considered as relating to the path of the resulting magnetic field which will be in a closed path, except for the at least one magnetic flux gap as will be appreciated by those skilled in the art.

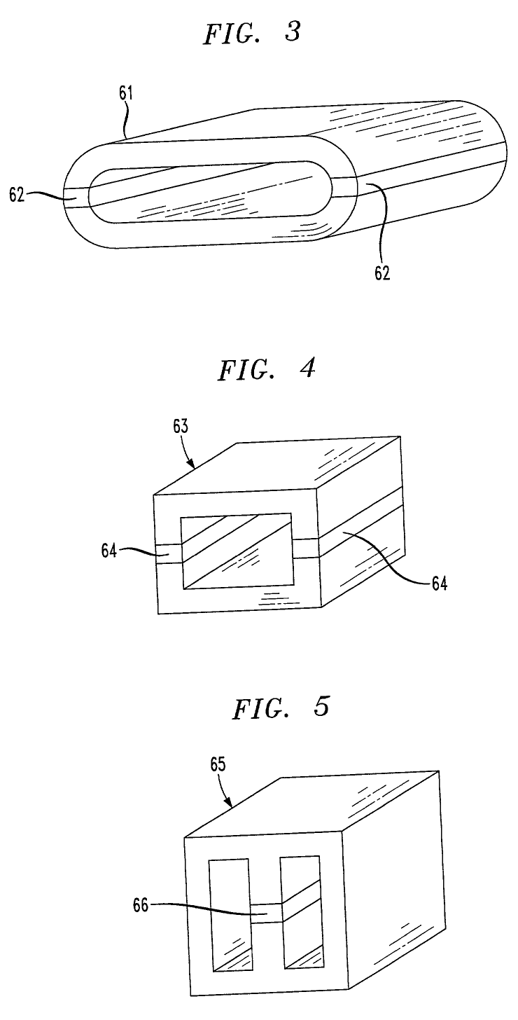

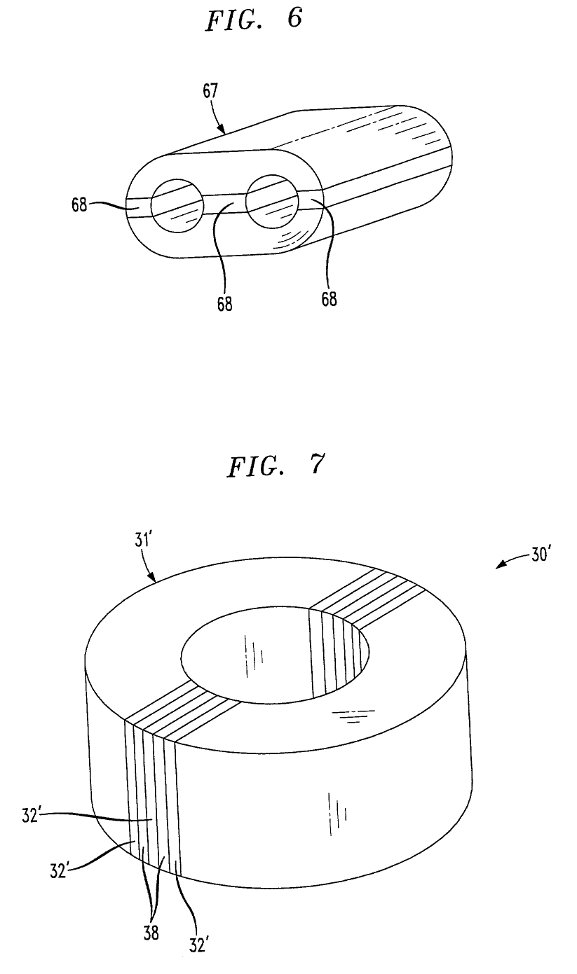

In particular, FIGS. 3-6 illustrate other closed-shape inductor cores in accordance with the present invention. An ellipsoidal core 61 with a pair of flux gaps 62 lying along the major axis is shown in FIG. 3. A “squaroidal” or square-shaped inductor core 63, also with flux gaps 64 lying along the major axis, is illustrated in FIG. 4. Similarly, an E-core 65 is shown in FIG. 5, and wherein the flux gap 66 is in the center leg thereof. In addition, FIG. 6 shows a “binocular” shaped core 67 with three flux gaps 68 aligned along the major axis. These are just representative alternate embodiments of closed-shape inductor cores of the present invention. Those of skill in the art will appreciate that other closed-shape inductors are also contemplated by the invention. For clarity of explanation, the remaining description with be directed to toroidal cores.

An alternative embodiment of a toroidal inductor 30′ is explained with reference to FIG. 7. The toroidal inductor 30′ is substantially the same as the toroidal inductor 30 in FIG. 1 except that its core 31′ includes a plurality of non-magnetic material portions 32′, and wherein adjacent portions are separated by spacers 38. These spacers 38 may include ferrite, for example. The non-magnetic material portions 32′ are substantially parallel to one another.

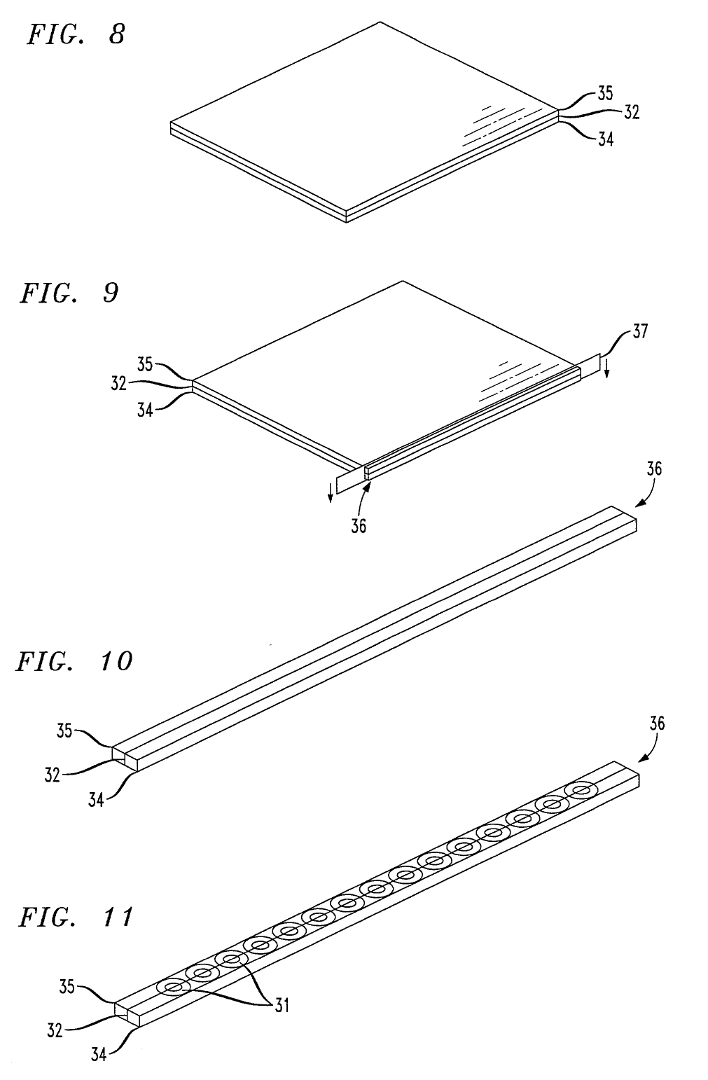

A method for making the toroidal inductor 30 will now be described with reference to FIGS. 8-11. A bottom layer 34 and a top layer 35 are stacked or joined together with an intermediate layer 32 therebetween. The bottom and top layers 34, 35 may include a Mn—Zn or a Ni—Zn ferrite composition, for example, to provide low loss and high permeability in a desired frequency range. The ferrite materials may be combined with binder additives and formed into roll compacted tape, for example. The bottom and top layer 34, 35 may be substantially equal in size and continuous. The bottom and top ferrite layers 34, 35 may also be formed by other conventional techniques as will be appreciated by those skilled in the art, such as using doctor blade techniques, for example. Other techniques include extrusion of the layers or slab compaction. This may permit larger devices to be manufactured without requiring a large number of thinner layers to be combined together to form an equivalent thickness.

The bottom, intermediate, and top layers 34, 32, 35 may be laminated together. The required outer diameter (OD) of the toroid to be produced determines the thickness of the laminated block of ferrite. Outer diameter sizes of up to about 0.400 inches may be readily produced in accordance with the invention, although even larger sizes are also possible.

The intermediate layer 32 is preferably non-magnetic and may be alumina or a zinc ferrite, for example. The zinc ferrite has a very low magnetic moment and appears almost inert. Both materials are readily used in conjunction with ferrite top and bottom layers to form a stable and mechanically rugged inductor. The intermediate layer 32 can be formed similarly to the top and bottom layers. Alternately, it can be formed by printing techniques as will be appreciated by those skilled in the art. Other materials may also be suitable for the intermediate layer 32, however, concern may also be given for mechanical strength in the finished toroidal inductor. In particular, adhesives which are sometimes used to join half toroids together may have low mechanical strength and be less stable at higher biases and temperatures than toroids made using ferrite for the top and bottom layers, and alumina or zinc ferrite for the intermediate layer 32.

As perhaps best understood with reference to FIGS. 9 and 10, the joined together layers are divided into a plurality of strips 36 using a blade 37, for example. Each strip 36 is punched to form a plurality of toroidal cores 30, and each toroidal core has the pair of magnetic flux gaps 32 therein provided by the layer of non-magnetic material as perhaps best seen in FIG. 11. The strips 36 may be rotated ninety degrees and laid flat (FIG. 6) for feeding into a press that performs the punching. An inner diameter (ID) and the OD are punched using tooling of desired dimensions to produce the toroidal cores 31.

The thickness of the intermediate layer 32 determines the thickness of the magnetic flux gap. For example, magnetic flux gaps 32 according to the present invention may have a thickness of less than about 0.02 inches, and, as small as 0.002 inches or less. Very precise gap control may be maintained by selecting nonmagnetic material and magnetic material that have substantially the same shrinkage factors during sintering as will be appreciated by those skilled in the art.

The punched toroidal cores 31 may be placed in a standard kiln, or can fall onto a conveyor system which takes the punched shapes into a kiln, for sintering. The residence time and atmosphere are controlled according to known practices that are suitable for the compositions used to provide a high permeability, as will be appreciated by those skilled in the art. The toroidal cores 31 may be tumbled in an abrasive medium to smooth any sharp edges. This reduces damage to the insulation on the conductor or wire 33 from being damaged when it is wound on the toroidal core 31. The finished toroidal inductor 30 may be tested by measuring permeability or inductance versus frequency under various amounts of bias.

To produce the toroidal core 30′, the same approach as described above is used except that a plurality of non-magnetic intermediate layers 32′ are stacked between the bottom and top layer 34, 35. Spacing layers 38 are also stacked or sandwiched between adjacent ones of the intermediate layers. Accordingly, the punching will form a plurality of toroidal cores 31′ each having a plurality of magnetic flux gaps as discussed above with relation to FIG. 7.

As noted above, magnetic flux gaps may be used to maintain the stability of a toroidal inductor. Upon gapping a toroidal core, the hysteresis loop of the material used to manufacture the core is “sheared” clockwise on its axis. As a result, a greater change in the drive H (i.e., DC bias) to produce the same change in a flux density B in the core is required than would have been the case without the magnetic flux gap. The change in effective permeability, and consequently the inductance, is then effected less with higher drive levels. The magnetic flux gap also has a mitigating effect on temperature stability by virtue of the reduced effective permeability. That is, a coefficient Δμ/μΔθ is effected by the ratio of μₑ/μ, where μₑ has been made less than μ as a result of the magnetic flux gap.

Because the magnetic flux gap produces poles on each surface of the magnetic flux gap face, the lines of force travel from one to the other and leakage or fringing results. As the magnetic flux gap is increased these lines do not travel normal to the faces, but instead travel in somewhat of an arc. This creates a fringing magnetic field around the magnetic flux gap. If the effective gap length is increased it is possible that this “stray field” may produce electromagnetic interference (EMI) by coupling with nearby components or traces.

It will be appreciated by those of skill in the art that the toroidal inductors 30 and 30′ produced according to the present invention provide relatively thin magnetic flux gaps 32, 32′, as described above, which lessen the occurrence of EMI. Even so, by extending the magnetic flux gaps 32, 32′ along the diameter of the toroidal inductors 30, 30′ (which may be conceptually thought of as two magnetic flux gaps aligned along radii 180 degrees from one another), a total gap length necessary to maintain inductive stability in numerous applications is still achieved.

Turning now additionally to FIG. 12, another embodiment of a toroidal inductor 40 according to the present invention will now be described. The toroidal inductor 40 illustratively includes a toroidal core 41 and a single magnetic flux gap 42a in the toroidal core. The toroidal inductor 40 is substantially the same as the toroidal inductor 30 discussed above except that only the single magnetic flux gap 42a is aligned along a radius R of the toroidal core 41. Of course, the flux gap 42a could be offset from the radius in other embodiments.

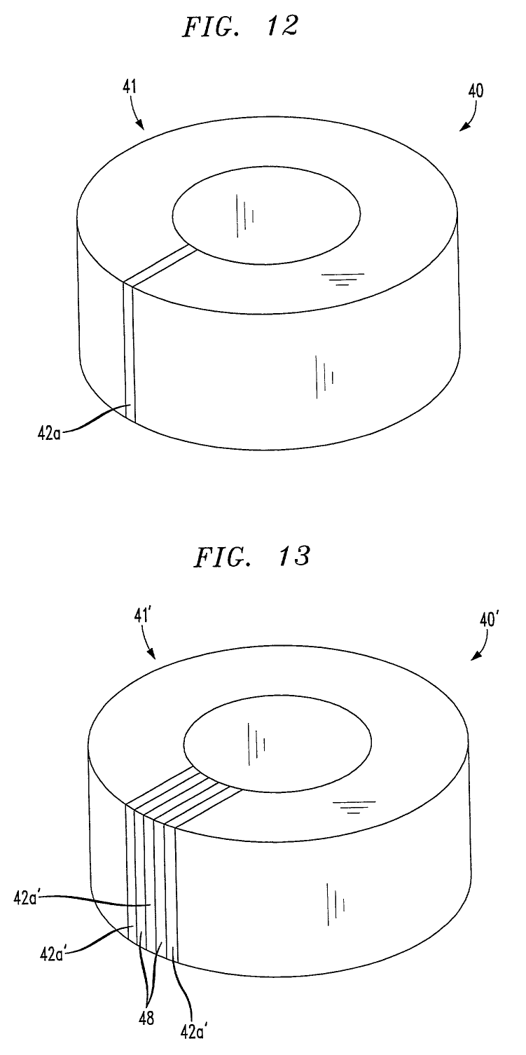

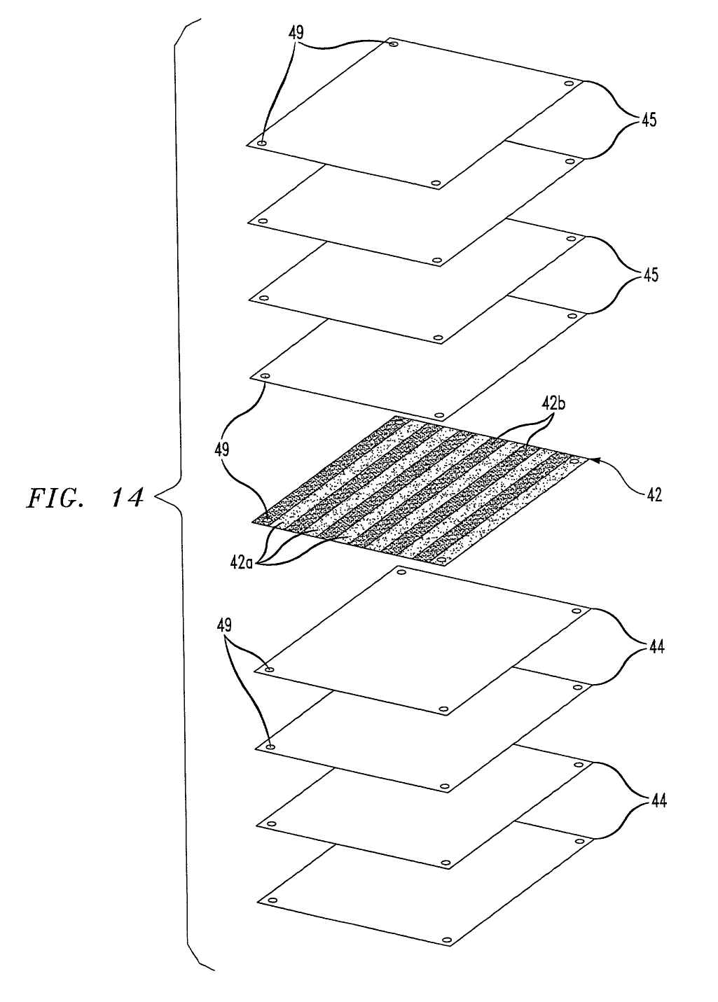

An alternate embodiment of a toroidal inductor 40′ is shown in FIG. 13. The toroidal inductor 40′ is substantially the same as the toroidal inductor 40 except that it includes a plurality of spaced apart magnetic flux gap portions 42a′, similar to the toroidal inductor 30′ discussed above. Spacer layers or portions 48 are sandwiched between adjacent non-magnetic material layers or portions 42′. The toroidal inductors 40, 40′ may be preferred in certain applications where less total gap length is required, for example.

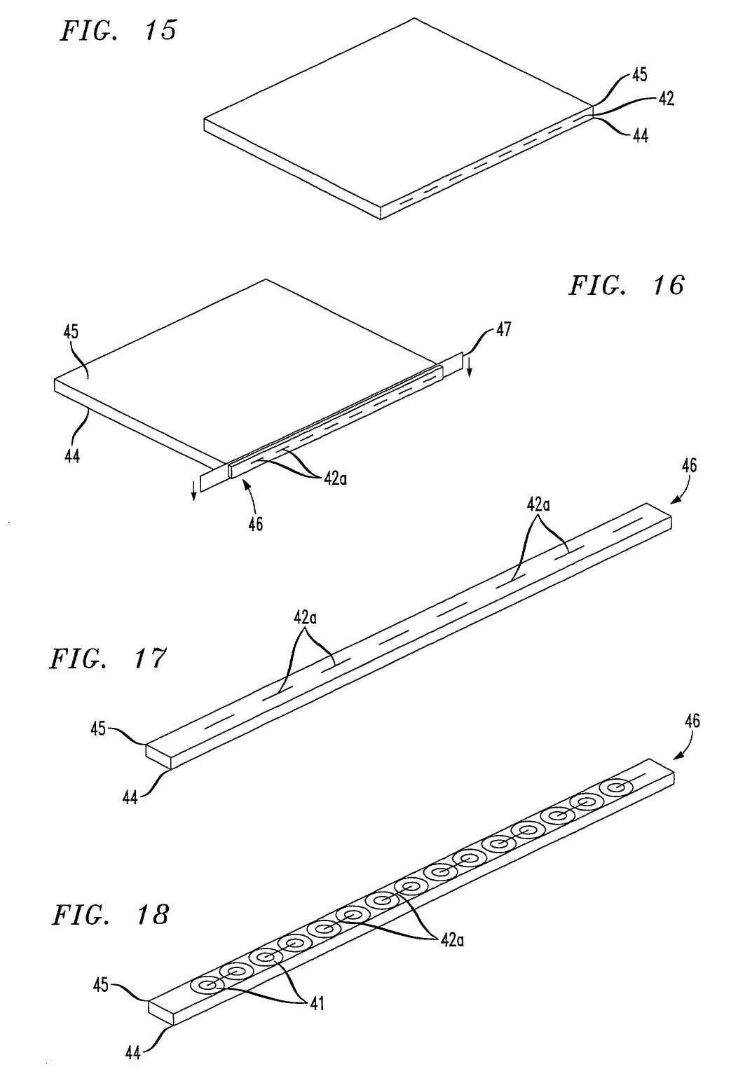

A method for making the toroidal inductor 40 will now be described with reference to FIGS. 14-18. The method is substantially the same as that described above with respect to FIGS. 8-11, and only the differences therebetween will be discussed for clarity of explanation. Bottom layers 44 and top layers 45 are stacked or joined together with an intermediate layer 42 therebetween. While multiple bottom and top layers 44, 45 are shown, those of skill in the art will appreciate that a single layer may also be used, as described above. Alignment holes 49 may be formed in each of the bottom, intermediate, and top layers 44, 42, 45 for aligning the bottom, intermediate, and top layers during stacking.

In contrast to the above described method, the illustrated intermediate layer 42 includes laterally alternating rows of the non-magnetic material 42a and magnetic material 42b. Thus, after the stacked layers have been laminated and divided with a blade 47, as seen in FIGS. 16 and 17, the strips 46 produced thereby have intermittent portions of the non-magnetic material 42a along a length of each strip, as seen perhaps best in FIG. 17. As such, the toroidal core 41 may be punched such that only a single magnetic flux gap 42a extends along a radius R of the toroidal core, as seen perhaps best in FIG. 18, to produce the toroidal inductor 40.

Again, similar to the toroidal inductor 30′, the toroidal inductor 40′ including a plurality of magnetic flux gap portions 42a′ may be produced by stacking a plurality of non-magnetic layers 42′ between the bottom layers 44′ and top layers 45′ and sandwiching separating or spacer layers 48a′ between adjacent non-magnetic layers.

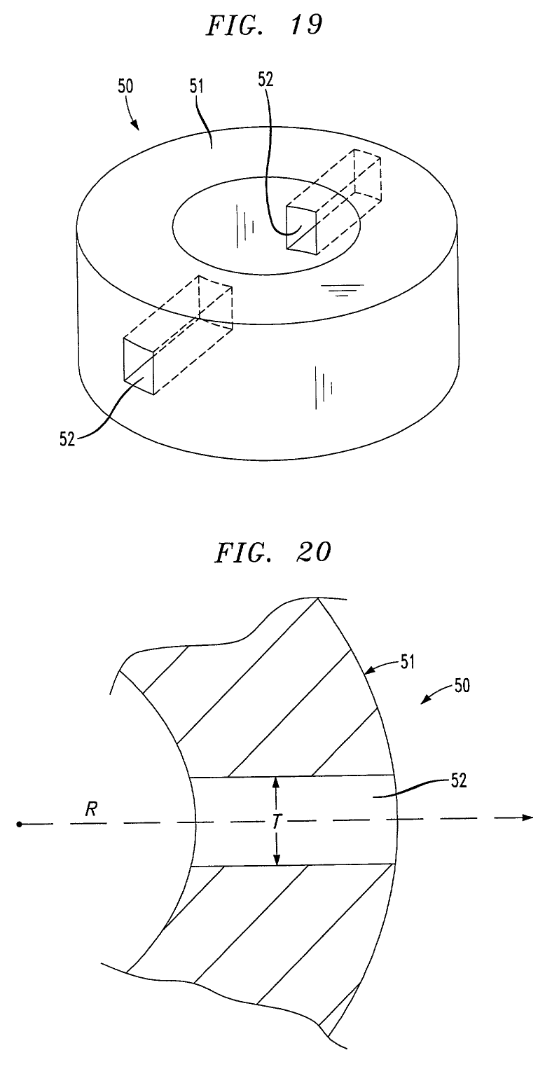

Yet another embodiment of a toroidal inductor 50 according to the present invention will now be described with reference to FIGS. 19 and 20. The toroidal inductor 50 is similar to the above described toroidal except that its toroidal core 51 illustratively has a magnetic flux gap defined by an air gap 52 that is within the toroidal core. In other embodiments, the air gap 52 may be replaced by another non-magnetic material, such as zinc ferrite or alumina.

The toroidal inductor 50 may otherwise have substantially the same features as described above with respect to the toroidal inductors 30, 30′, 40, 40′. For example, the air gap 52 may extend along a radius or a diameter of the toroidal core 51, there may be a plurality of magnetic flux gaps 52, the toroidal core may comprise ferrite, etc.

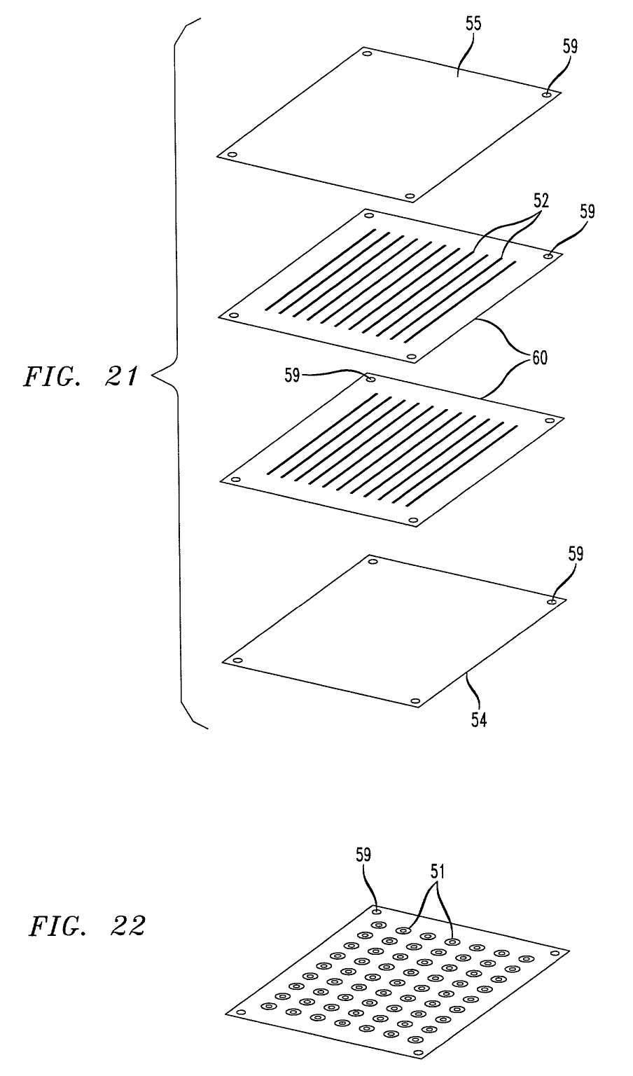

A method for making the toroidal inductor 50 will now be described with reference to FIGS. 21 and 22. The materials and steps included in such method are similar to those discussed above and only the differences therebetween will be discussed herein. A bottom layer 54 and a top layer 55 are stacked together with intermediate layers 60 therebetween. Once again, multiple bottom and top layers 54, 55, or a single intermediate layer 60, may be used. The number of layers used and thickness of the layers will depend upon the desired application as well as other design considerations, as will be readily appreciated by those of skill in the art.

The intermediate layers 52 include a plurality of rows of a non-magnetic material. For example, the rows may be punched so that they are air gaps or the rows may be a solid material, such as zinc ferrite. Alignment holes 59 may also be used to align the various layers and particularly the rows 52 in the intermediate layers 60.

After the layers have been stacked and laminated, rather than dividing a strip from the stacked layers and placing the strips on their sides, as described above, the stacked layers are punched through the top layer 55, for example, to form a plurality of toroidal cores 51 that extends along a diameter of the toroidal core. Each toroidal core 51 thereby has a magnetic flux gap 52 confined therein. The stacked layers may still be cut into strips as described above for convenience of processing, but for this method they would be punched either through the bottom or top layer 54, 55, rather than from a side of the strips.

Of course, those skilled in the art will appreciate that the rows 52 may include intermittently spaced portions of non-magnetic material and ferrite, for example, to produce a toroidal core 51 with a magnetic flux gap 52 extending along a radius thereof, for example. A plurality of magnetic flux gaps 52 may also be provided in a similar fashion to that described above.

Furthermore, many additional modifications and other embodiments of the invention will come to the mind of one skilled in the art having the benefit of the teachings presented in the foregoing descriptions and the associated drawings. The embodiments described above are representative examples of the numerous toroidal inductors that may be provided according to the present invention. Therefore, it is to be understood that the invention is not to be limited to the specific embodiments disclosed, and that other modifications and embodiments are intended to be included within the scope of the appended claims.

That which is claimed is:

1. A toroidal inductor comprising:
a toroidal core comprising magnetic material and having at least one magnetic flux gap therein;
said at least one magnetic flux gap comprising a non-magnetic material having a substantially uniform thickness between respective adjacent magnetic material portions and having a shrinkage factor during sintering substantially equal to a shrinkage factor of the magnetic material; and
at least one conductor wound on said toroidal core.

2. The toroidal inductor of claim 1 wherein said at least one flux gap extends along at least one respective radius of said toroidal core.

3. The toroidal inductor of claim 1 wherein said at least one magnetic flux gap comprises a single flux gap.

4. The toroidal inductor of claim 3 wherein said single flux gap extends along a radius of said toroidal core.

5. The toroidal inductor of claim 1 wherein said at least one magnetic flux gap comprises a pair of flux gaps.

6. The toroidal inductor of claim 5 wherein said pair of flux gaps are aligned along opposing radii of said toroidal core.

7. The toroidal inductor of claim 1 wherein said at least one magnetic flux gap comprises a plurality of non-magnetic material layers and spacer layers between adjacent ones thereof.

8. The toroidal inductor of claim 7 wherein each spacer layer comprises ferrite.

9. The toroidal inductor of claim 1 wherein said magnetic material comprises ferrite; and wherein said non-magnetic material comprises at least one of alumina and zinc ferrite.

10. The toroidal inductor of claim 1 wherein the thickness of said at least one magnetic flux gap is less than about 0.02 inches.

11. A toroidal inductor comprising:
a toroidal core comprising ferrite and having at least one magnetic flux gap therein;
said at least one magnetic flux gap comprising at least one of alumina and zinc ferrite having a substantially uniform thickness between respective adjacent magnetic material portions; and
at least one conductor wound on said toroidal core.

12. The toroidal inductor of claim 11 wherein said at least one flux gap extends along at least one respective radius of said toroidal core.

13. The toroidal inductor of claim 11 wherein said at least one magnetic flux gap comprises a single flux gap.

14. The toroidal inductor of claim 13 wherein said single flux gap extends along a radius of said toroidal core.

15. The toroidal inductor of claim 11 wherein said at least one magnetic flux gap comprises a pair of flux gaps.

16. The toroidal inductor of claim 15 wherein said pair of flux gaps are aligned along opposing radii of said toroidal core.

17. The toroidal inductor of claim 11 wherein said at least one magnetic flux gap comprises a plurality of non-magnetic material layers and spacer layers between adjacent ones thereof.

18. The toroidal inductor of claim 11 wherein the thickness of said at least one magnetic flux gap is less than about 0.02 inches.

19. A toroidal inductor comprising:
a toroidal core comprising non-magnetic material and having at least one magnetic flux gap therein;
said at least one magnetic flux gap comprising a plurality of non-magnetic material layers and spacer layers between adjacent ones thereof, said at least one magnetic flux gap having a substantially uniform thickness between respective adjacent ferrite portions; and
at least one conductor wound on said toroidal core.

20. The toroidal inductor of claim 19 wherein said at least one flux gap extends along at least one respective radius of said toroidal core.

21. The toroidal inductor of claim 19 wherein said at least one magnetic flux gap comprises a single flux gap.

22. The toroidal inductor of claim 21 wherein said single flux gap extends along a radius of said toroidal core.

23. The toroidal inductor of claim 19 wherein said at least one magnetic flux gap comprises a pair of flux gaps.

24. The toroidal inductor of claim 23 wherein said pair of flux gaps are aligned along opposing radii of said toroidal core.

25. The toroidal inductor of claim 19 wherein said magnetic material and each spacer layer comprises ferrite; and wherein said non-magnetic material comprises at least one of alumina and zinc ferrite.

26. The toroidal inductor of claim 19 wherein the thickness of said at least one magnetic flux gap is less than about 0.02 inches.

27. A toroidal inductor comprising:
a toroidal core comprising substantially continuous top and bottom portions, each comprising magnetic material, said toroidal core having at least one magnetic flux air gap therein;
said at least one magnetic flux air gap having a substantially uniform thickness between respective adjacent ferrite portions and being contained within the top and bottom portions; and
at least one conductor wound on said toroidal core.

28. The toroidal inductor of claim 27 wherein said at least one magnetic flux air gap comprises a single magnetic flux air gap.

29. The toroidal inductor of claim 28 wherein said single magnetic flux air gap is aligned along a radius of said toroidal core.

30. The toroidal inductor of claim 27 wherein said at least one magnetic flux air gap comprises a pair of magnetic flux air gaps.

31. The toroidal inductor of claim 30 wherein said pair of magnetic flux air gaps are aligned along opposing radii of said toroidal core.

32. The toroidal inductor of claim 27 wherein the magnetic material comprises ferrite.

33. The toroidal inductor of claim 27 wherein the thickness of said at least one magnetic flux gap is less than about 0.02 inches.
